(19) United States
(12) Patent Application Publication
(10) Pub. No.: US 2025/0155054 A1
(43) Pub. Date: May 15, 2025

(54) Support System for Conduit and Cables

(71) Applicant: ERICO International Corporation, Solon, OH (US)

(72) Inventor: Dennis R. Young, Amherst, OH (US)

(21) Appl. No.: 18/948,250

(22) Filed: Nov. 14, 2024

Related U.S. Application Data
(60) Provisional application No. 63/598,757, filed on Nov. 14, 2023.

(51) Int. Cl. F16L 3/12; F16L 3/223

(52) U.S. Cl. CPC F16L 3/12; F16L 3/223

(57) ABSTRACT

A support assembly for conduit may include a support member extending in a lateral direction with an opening to receive a conduit along an axial direction, and a support clip. The support clip may include a bridge section extending axially with a bridge inner profile facing radially inwardly. The support clip may include first and second lateral arms extending radially outwardly from opposite lateral sides of the bridge section to define respective first and second outer profiles, which may each include indents selectively engageable with first and second lateral sides of the opening to secure the clip against axial movement. The support clip may include spring arms extending from opposite axial ends of the bridge section, which may be resiliently deflectable relative to the bridge section to engage inner spring arm profiles with a conduit at a range of conduit diameters.

### CROSS-REFERENCE TO RELATED APPLICATIONS

This application claims priority to and incorporates by reference U.S. provisional patent application No. 63/598,757, filed Nov. 14, 2023.

### BACKGROUND

In many applications, it may be useful to suspend equipment such as conduit, pipe, and coated conductors from a ceiling or other structure of a building. Suspending the equipment from the ceiling may help to create extra usable space in an interior of the building.

### SUMMARY

A support assembly for supporting cable or conduit may include a support member that extends in a lateral direction and includes an opening arranged to receive a conduit along an axial direction along a conduit axis. The support assembly may include a support clip. The support clip may integrally include a bridge section that extends axially to define a bridge inner profile that faces radially inwardly. The support clip may include first and second lateral arms extending radially outwardly from opposite lateral sides of the bridge section to define respective first and second outer profiles. The first and second outer profiles may each include indents selectively engageable with first and second lateral sides of the opening to secure the support clip against axial movement relative to the support member. The support clip may include spring arms extending from opposite axial ends of the bridge section to define inner spring arm profiles. The spring arms may be resiliently deflectable relative to the bridge section to resiliently engage the inner spring arm profiles with a conduit at a range of conduit diameters.

A support clip for supporting cable or conduit may include a bridge section that may be concave toward a reference conduit axis. The bridge section may include an apex bend, a first bridge side extending radially inwardly from a first lateral side of the apex bend and a second bridge side extending radially inwardly from a second lateral side of the apex bend, relative to the reference conduit axis. The support clip may include a first lateral arm extending radially outwardly, relative to the reference conduit axis, from the first bridge side to a tapered, notched first outer profile. The support clip may include a second lateral arm extending radially outwardly, relative to the reference conduit axis, from the second bridge side to a tapered, notched second outer profile. The support clip may include one or more first spring arms extending radially inwardly, relative to the reference conduit axis, and in a first axial direction away from the bridge section, and one or more second spring arms extending radially inwardly, relative to the reference conduit axis, and in a second axial direction away from the bridge section. The first and second outer profiles may be engageable with sides of an opening of a support member to secure the support clip against axial movement. The one or more first spring arms and one or more second spring arms may be resiliently engageable, at a range of conduit diameters, with a conduit extending through the opening along the reference conduit axis.

Some embodiments provide a method of supporting conduit relative to a support member that extends in a lateral direction. The method may include inserting a length of conduit in an axial direction into an opening in the support member, to extend along a conduit axis. The method may include inserting a support clip for conduit into the opening, in the axial direction, so that a bridge section of the support clip may extend axially along the conduit, with a bridge inner profile facing radially inwardly relative to the conduit axis, and with first and second lateral arms extending radially outwardly from opposite lateral sides of the bridge section. The support clip may be inserted so that indents of first and second outer profiles of the first and second lateral arms may selectively engage first and second lateral sides of the opening to secure the support clip against axial movement relative to the support member. The support clip may be inserted so that spring arms that extend from opposite axial ends of the bridge section may resiliently deflect relative to the bridge section to resiliently engage inner profiles of the spring arms with the conduit at a conduit diameter.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an isometric view of a support system according to an example of the disclosed technology.

FIG. 2 is a top isometric view of a support the support system of FIG. 1.

FIG. 3 is a bottom isometric view of the support insert of the support system of FIG. 1.

FIG. 4 is a side elevation view of the support insert of the support system of FIG. 1.

FIG. 5 is an isometric view of a support system according to an example of the disclosed technology.

FIG. 6 is a top isometric view of an example configuration of a support of the support system of FIG. 5.

FIG. 7 is a bottom isometric view of the support the support system of FIG. 5.

FIG. 8 is a side elevation view of the support of the support system of FIG. 5.

FIG. 9 is an axonometric view of a support system according to an example of the disclosed technology.

FIG. 9A is a side elevation of the support system of FIG. 9, including a support insert in a pre-installed configuration.

FIG. 9B is a side elevation of the support system of FIG. 9, including the support insert in a first installed configuration.

FIG. 9C is a side elevation of the support system of FIG. 9, including the support insert in an intermediate configuration between the first installed configuration and a second installed configuration.

FIG. 9D is a side elevation of the support system of FIG. 9, including the support insert in the second installed configuration.

FIG. 9E is a side elevation of the support system of FIG. 9, including the support insert in a third installed configuration.

FIG. 10 is a top isometric view of the support insert of the support system of FIG. 9.

FIG. 11 is a bottom isometric view of the support insert of the support system of FIG. 9.

FIG. 12 is a side elevation view of the support insert of the support system of FIG. 9.

FIG. 13 is a front elevation view of the support insert of the support system of FIG. 9.

FIG. 14 is a rear elevation view of the support insert of the support system of FIG. 9.

FIG. 15 is a top isometric front view of another support insert according to an example of the disclosed technology.

FIG. 16 is a top isometric rear view of the support of FIG. 15.

FIG. 17 is a front elevation view of the support of FIG. 15.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, in some contexts, it may be useful to suspend equipment (e.g., conduit, pipe, cables, and other conductors) above the ground in buildings. Multiple lengths of such equipment are often run in parallel (or otherwise) and collectively suspended from a ceiling or other overhead support structure. Conventional configurations of such support systems can require the conduit to be suspended using horizontal support struts that are threadedly connected to a ceiling via a hanger bar.

In some configurations, the support struts may include one or more apertures configured to receive and retain the equipment. When installed in the apertures for service the equipment may vibrate or otherwise move, potentially causing unwanted noise or abrasion to the equipment. The narrow edge of each aperture may further catch ridged or roughened equipment surfaces, potentially causing difficulties for installers attempting to push or pull the equipment through the apertures.

Embodiments of the present invention may address these and other issues, including by providing a support configured to engage and secure equipment (e.g., conduit, pipe, and coated conductors) against an edge of an aperture of a trapeze member, to reduce vibration, abrasion, and installation time for the equipment into the apertures of a trapeze member or other support. Using a support as disclosed may also ease the install of the equipment, by protecting and providing less resistance for equipment that is pulled or pushed through the apertures of the trapeze members.

In some embodiments, a support system may include a trapeze member for supporting equipment having a plurality of apertures configured to receive and retain equipment. The equipment may be inserted through one or more of the apertures in an insertion direction (e.g., a direction that is perpendicular to or otherwise transverse to a plane defined by the aperture(s) or a structure of the trapeze member that includes the apertures). At least one of the plurality of apertures may include a support having a support surface configured to clamp the equipment within the aperture.

Some examples of the disclosed technology can be beneficially formed as laterally symmetric clips. Accordingly, in some examples below, discussion of a first lateral side of a clip may apply equally to a second lateral side of a clip (e.g., albeit with reversed directionality). In some examples, however, different lateral sides of a clip can exhibit different (e.g., asymmetric) profiles.

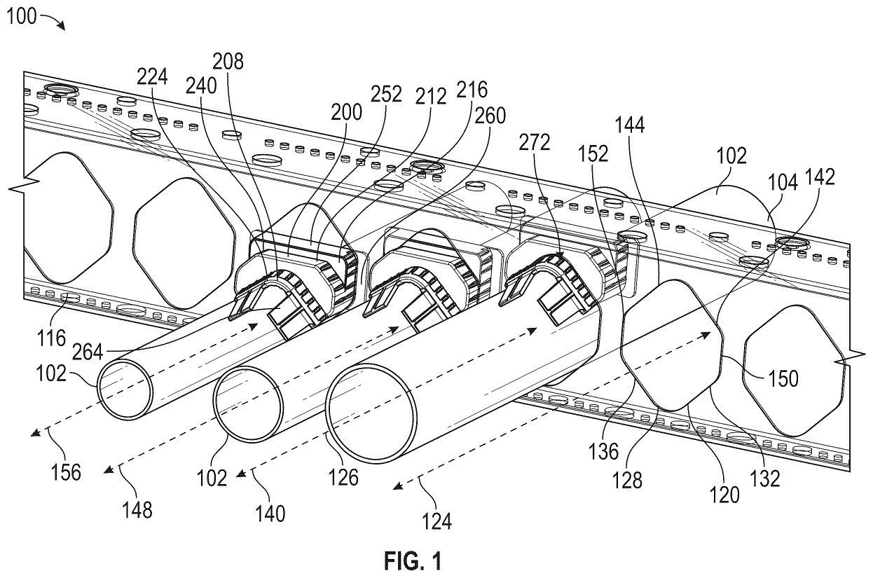

As one example, FIG. 1 illustrates a support system 100 for receiving and retaining one or more elongate members 102 (e.g., a length of conduit 104, a metal clad cable, an insulated cable, a pipe, or other elongate structure (not shown)). In the illustrated example, the support system 100 may include a trapeze member 116. The trapeze member 116 may be a bar that is configured to be attached to a ceiling, wall, or other structure (not shown). The trapeze member 116 may be coupled directly to the structure via fasteners (not shown), or may alternatively be hung from one or more rods (not shown) that are coupled to the structure. Of note, although examples below focus on trapeze arrangements configured to support relative to building structures at opposite ends of a support member (e.g., the member 116), other examples can be configured for attachment to building structures in other ways (e.g., as variously known in the art for support of conduit, cables, etc.)

The trapeze member 116 may extend in a lateral direction (e.g., substantially parallel to horizontal), and may include one or more apertures 120 arranged to receive and retain one or more of the elongate members 102. The elongate members 102 may be inserted into the apertures 120 along an axial direction along an insertion axis (e.g., a conduit axis) that extends perpendicularly from a center of each of the apertures 120, relative to a face of the apertures 120—as shown for axis 124, for example, which may be substantially parallel to horizontal and substantially perpendicular to the lateral direction. In this regard, the elongate members 102 may be inserted in a first insertion direction, substantially parallel to the relevant insertion axis, or in a second insertion direction opposite the first insertion direction, and also substantially parallel to the insertion axis. In some examples, the elongate members 102 may each define a member axis 126 that extends through a center of the elongate members 102. As illustrated in FIG. 1, during or after installation of the elongate members 102 within the apertures 120, the member axis 126 may be substantially parallel to the insertion axis 124.

Generally, some apertures can be formed a polygonal apertures, to provide improved engagement with a conduit clip or other accessories. For example, in the illustrated embodiment, the apertures 120 are hexagonal in shape. Correspondingly, the illustrated hexagonal apertures 120 includes a first vertex 128 that points toward the ground, when the trapeze member 116 is installed. In some example, as shown in FIG. 1, each aperture 120 (or some of the apertures 120) may include a first aperture edge 132 and a second aperture edge 136, connected by the first vertex 128 (e.g., to define, respectively, first and second liner edge segments separated by a curved edge segment). When installed, the elongate members 102 retained by the apertures 120 may be urged by gravity toward the first vertex 128, so that the elongate members 102 may generally rest on the first aperture edge 132 and the second aperture edge 136 (absent inclusion of intervening structure). In such configurations, the elongate members 102 may advantageously experience two points of contact, further stabilizing the elongate members 102 within the apertures 120, although some arrangements can include objects supported on only one of the two edges 132, 136 (or otherwise supported). However, although examples of the present disclosure focus on a hexagonal configuration for the apertures 120, it is noted that the apertures 120 may be any shape (e.g., circular, rectangular, diamond-shaped, triangular, other regular or irregular polygon, etc.).

As noted above, the structure of the trapeze member 116 may allow for movement or vibration of the elongate members 102, potentially creating excess noise. Correspondingly, the support system 100 may include one or more support clips configured to clamp the elongate members 102 within and relative to one or more of the apertures 120.

For example, as shown in FIG. 1 a support clip 200 is configured to mitigate vibration of the elongate members 102 within the aperture 120. In some cases, multiple substantially identical (or other) support clips can simultaneously engage multiple of the elongate members 102 within the corresponding apertures 120. In some embodiments, the support clip 200 can be configured to engage the elongate members 102 at various diameters and thus accommodate difference possible sizes of the elongate members 102. In some embodiments, the support clip 200 engages the corresponding elongate member 102 against the corresponding aperture edges, e.g., the first aperture edge 132 and the second aperture edge 136 as shown in FIG. 1, although another insert or other intervening structure can be provided in some cases.

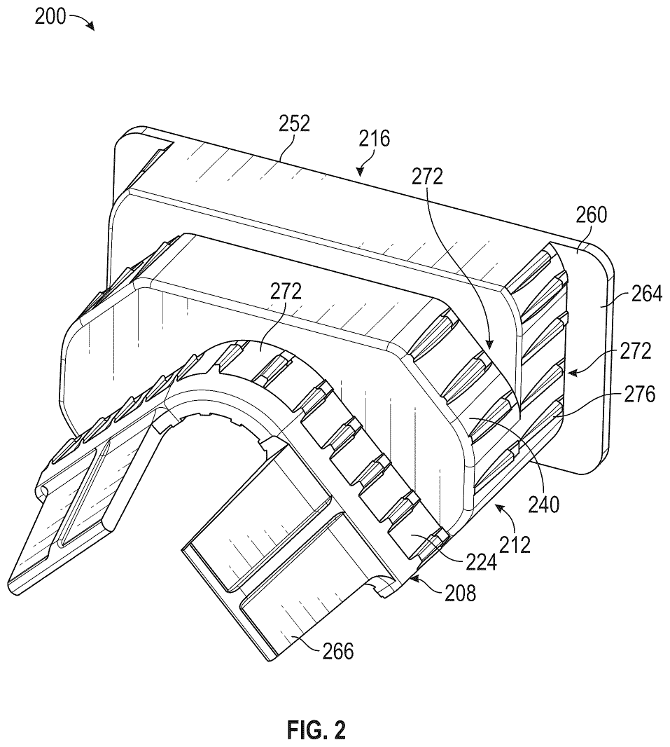

FIGS. 2-4 illustrate details of an example configuration of the support clip 200. In the example shown, the support clip 200 may include one or more tiers configured to allow the support clip 200 to engage one or more different diameters of the elongate member 102 (as shown in FIG. 1). For example, the support clip 200 may include a first tier 208, a second tier 212, and a third tier 216. In some cases, fewer or more tiers can be included (e.g., only the first tier 208 and either of the second or third tiers 212, 216)

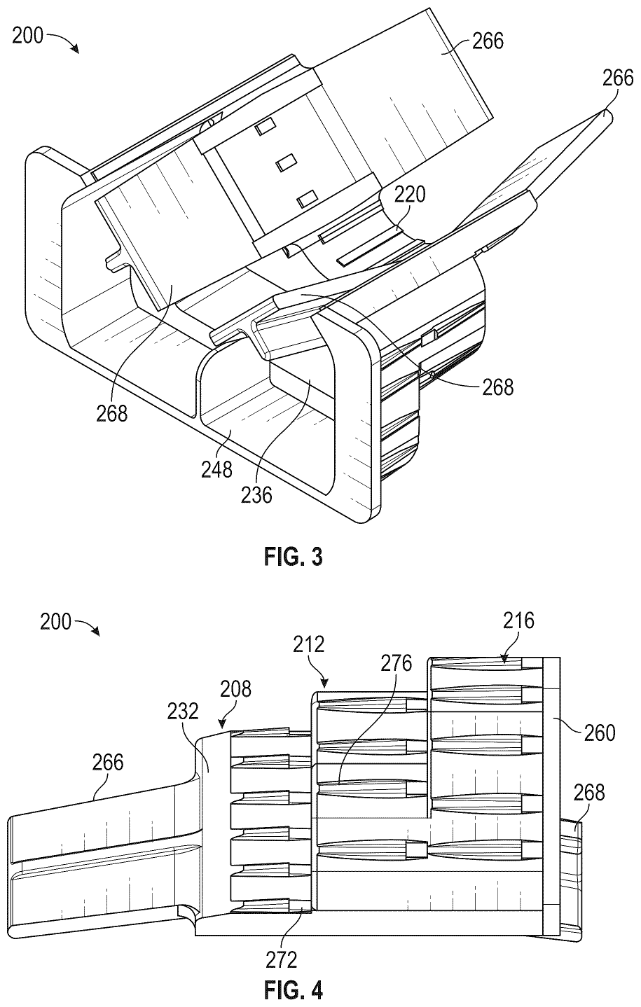

As illustrated in FIG. 3, the first tier 208 may define a first inner profile 220 that is sized to receive (e.g., provide clearance for) an elongate member 102a (see FIG. 1) extending along a first member axis 140. In some embodiments, the first member axis 140 extends through a center of the elongate member 102a. Furthermore, the elongate member 102a may define a relatively large diameter, measured radially relative to the first member axis 140. Additionally, the first tier 208 may define a first outer (sub) profile 224 (see FIG. 2) configured to extend with a first maximum spacing from the first member axis 140 when installed as shown in FIG. 1.

Generally, the clip 200 can define one or more outer profiles, with various sub-profiles as applicable, to selectively secure conduit of different sizes. For example, also as shown in FIG. 1, the first outer (sub-) profile 224 may be configured to engage one or more of the edges of the aperture 120. For example, the first outer profile 224 of the first tier 208 may be sized to engage (e.g., seat on) a third aperture edge 142 and a fourth aperture edge 144, disposed opposite the first aperture edge 132 and second aperture edge 136, respectively. The first outer profile 224 may further engage a vertex opposite the first vertex 128, at an apex of the aperture 120.

The first tier 208 may generally extend from a first end 232 of the support clip 200, to the second tier 212. In some embodiments, the first tier 208 may extend substantially parallel (axial) relative to the first member axis 140.

As illustrated in FIG. 3, the second tier 212 may define a second inner profile 236 sized to receive (e.g., provide clearance for) an elongate member 102b extending along a second member axis 148 (see FIG. 1). In some embodiments, the elongate member 102b may define a diameter that is smaller than the diameter of the elongate member 102a. Referring to FIG. 4, the second tier 212 may define a second outer (sub-) profile 240 configured to extend with a second maximum spacing from the second member axis 148 when installed as shown in FIG. 1.

Also as shown in FIG. 1, the second outer profile 240 may be configured to engage one or more of the edges of the aperture 120. The second outer profile 240 may be configured to engage an upper section of the aperture 120. For example, the second outer profile 240 of the second tier 212 may engage the third aperture edge 142 and the fourth aperture edge 144. In some embodiments, the second outer profile 240 of the second tier 212 may also (or alternatively) engage a fifth aperture edge 150 and a sixth aperture edge 152 of the aperture 120. The fifth aperture edge 150 may connect the first aperture edge 132 and the third aperture edge 142. The sixth aperture edge 152 may connect the second aperture edge 136 and the fourth aperture edge 144.

In some embodiments, the second maximum spacing may be larger than the first maximum spacing. The second tier 212 may extend from the first tier 208 to the third tier 216. In some embodiments, the second tier 212 may extend substantially parallel (axial) relative to the second member axis 148. In some embodiments, the first member axis 140 and the second member axis 148 may be substantially parallel. In some embodiments, the first tier 208 may extend from the second tier 212 in a first direction that is substantially parallel to the first member axis 140.

As illustrated in FIG. 3, the third tier 216 may define a third inner profile 248 sized to receive (e.g., provide clearance for) an elongate member 102c extending along a third member axis 156. The elongate member 102c may define a diameter that is smaller than the diameters of the elongate members 102a, 102b. Referring to FIG. 4, the third tier 216 may define a third outer (sub-) profile 252 configured to extend with a third maximum spacing from the third member axis 156 when installed as shown in FIG. 1. In some examples, the third maximum spacing may be larger than the second maximum spacing.

Also as shown in FIG. 1, the third outer profile 252 may be configured to engage one or more of the edges of the aperture 120. The third outer profile 252 may be configured to engage a middle section of the aperture 120, below the upper section. For example, the third outer profile 252 of the third tier 216 may engage the fifth aperture edge 150 and the sixth aperture edge 152. In some embodiments, the third outer profile 252 may further engage a vertex disposed between the third aperture edge 142 and the fifth aperture edge 150 and a vertex disposed between the fourth aperture edge 144 and the sixth aperture edge 152.

In some embodiments, the third tier 216 may extend from the second tier 212 to a flange 260. In some embodiments, the flange 260 may define a fourth outer (sub-) profile 264. In some embodiments, the third tier 216 may extend substantially parallel (axial) relative to the third member axis 156. In some embodiments, the first member axis 140 and the third member axis 156 may be substantially parallel. In some embodiments, the second tier 212 may extend from the third tier 216 in the first direction.

The support clip 200 may include one or more sets of spring arms to resiliently engage conduit received through a corresponding aperture. Referring to FIG. 1, the sets of spring arms may be generally configured to resiliently deform to engage the elongate members 102 and thereby urge the elongate members 102 against the first aperture edge 132 and the second aperture edge 136 (or other relevant surface).

As one example, as illustrated in FIG. 3, the support clip 200 may include a first set of spring arms 266. The first set of spring arms 266 may extend from the first end 232 of the support clip 200 (e.g., may extend from the first tier 208). The first set of spring arms 266 may extend generally in the first direction, and at an oblique angle relative to the first member axis 140 (see FIG. 1).

In some embodiments, the support clip 200 may include a second set of spring arms 268. The second set of spring arms 268 may extend from the first inner profile 220. The second set of spring arms 268 may generally extend in a second direction, opposite the first direction, and also at an oblique angle relative to the first member axis 140 (see FIG. 1). In other words, as generally illustrated in FIG. 4, the first set of spring arms 266 and the second set of spring arms 268 may extend toward relevant axes of supported elongate members (e.g., the axes 140, 148, 156 of FIG. 1).

In some embodiments, the first set of spring arms 266 and the second set of spring arms 268 each include one or more spring arms. For example, the first set of spring arms 266 and the second set of spring arms 268 may each include two spring arms. In some embodiments, sets of spring arms may instead or also extend from the second tier 212 or the third tier 216.

Referring to FIG. 4, in some embodiments, the one or more arms of the first set of spring arms 266 and the second set of spring arms 268 may each include a ridge extending along a length of each of the one or more arms, parallel to the first member axis 140. In some embodiments, the ridge disposed on each of the one or more arms may provide extra rigidity, to aid the engagement of the elongate members 102 against the first aperture edge 132 and the second aperture edge 136.

Referring to FIG. 1, the first outer profile 224, the second outer profile 240, and the third outer profile 252 may each be configured to engage one or more different edges of the aperture 120. Accordingly, the first outer profile 224, the second outer profile 240, the third outer profile 252, and the fourth outer profile 264 may each be a unique shape. For example, the first outer profile 224 may be triangular in shape, the second outer profile 240 may be hexagonal in shape, the third outer profile 252 may be rectangular in shape, or the fourth outer profile 264 may be rectangular in shape. Or, in other examples, a variety of other shapes are possible (e.g., circular, triangular, rectangular, pentagonal, hexagonal, octagonal, or other shapes).

In some examples, an outer profile can include a channel or other structure to engage with corresponding edges of a support aperture. For example, referring to FIG. 2, the support clip 200 includes one or more channels 272 disposed on the first outer profile 224, the second outer profile 240, or the third outer profile 252. In particular, as illustrated in FIG. 4, each of the first outer profile 224, the second outer profile 240, and the third outer profile 252 can include one or more of the channels 272. The channels 272 may generally extend transverse to the first member axis 140, the second member axis 148, and the third member axis 156.

As shown in FIG. 1, the one or more channels 272 may receive and retain the edges of the aperture 120 to secure the support clip 200 within the aperture 120. In some embodiments, one of the channels 272 may receive the edge of the aperture 120, when the support clip 200 is inserted into the aperture 120 parallel to the insertion axis 124. In some embodiments, the support clip 200 may be inserted through the aperture 120 in the first direction or in the first insertion direction.

Referring to FIG. 4, in some embodiments, the one or more channels 272 may be defined by a plurality of protrusions 276. The protrusions 276 may extend parallel to the first member axis 140, the second member axis 148, and the third member axis 156. In some embodiments, the protrusions 276 disposed on the first tier 208 may be axially separated from the second tier 212, relative to the first member axis 140. Thus, one of the channels 272 disposed on the first tier 208 may be defined by the axial separation between the protrusions 276 and the second tier 212. Similarly, the protrusions 276 disposed on the second tier 212 may be axially separated from the third tier 216, relative to the second member axis 148, to form one of the channels 272. Also, the protrusions 276 disposed on the third tier 216 may be axially separated from the flange 260, relative to the third member axis 156 to form one of the channels 272.

A method of supporting the elongate member 102 within the aperture 120 may include inserting the elongate member 102 into the aperture in the first insertion direction. The support clip 200 may be correspondingly (e.g., afterwards) inserted into the aperture 120 in the first insertion direction (or opposite) so that the first tier 208, the second tier 212, or the third tier 216 may engage the edges of the aperture 120. The first or second set of spring arms 266, 268 may correspondingly resiliently engage the elongate member 102 to help secure the elongate member 102 within the relevant aperture 120.

In some embodiments, the elongate member 102 is selectively any one of a first conduit with a first diameter, a second conduit with a second diameter smaller than the first diameter, or a third conduit with a third diameter smaller than the second diameter. In some embodiments, the support clip 200 is configured to engage the selected first, second, or third conduit, against the first aperture edge 132 and the second aperture edge 136. In some embodiments, the first conduit is retained in the aperture 120 when the first outer profile 224 of the first tier 208 engages the edges of the aperture 120, In some embodiments, the second conduit is retained in the aperture 120 when the second outer profile 240 of the second tier 212 engages the edges of the aperture 120. In some embodiments, the third conduit is retained in the aperture 120 when the third outer profile 252 of the third tier 216 engages the edges of the aperture 120.

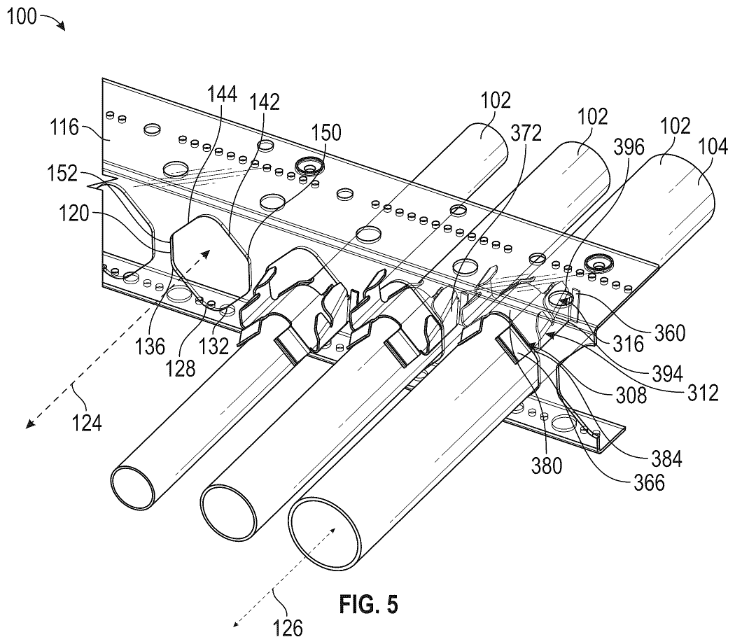

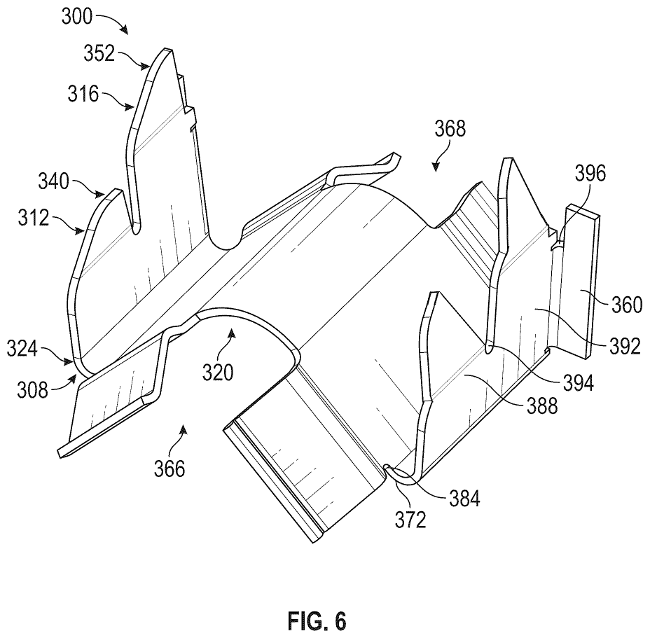

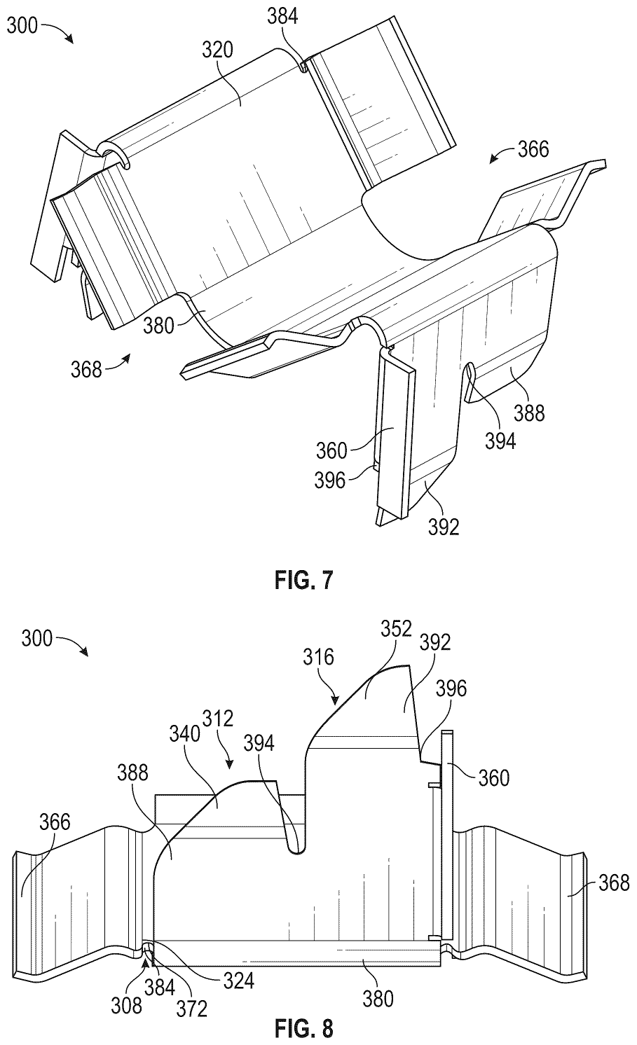

In some examples, a support can be cold formed (e.g., stamped). FIGS. 5 and 6-8 illustrate example configurations of a support clip 300, with different bend configurations for associated lateral arms. The support clip 300 of FIGS. 5-8 may generally include similar features as the support clip 200 of FIGS. 1-4, including but not limited to a first tier 308, a second tier 312, a third tier 316, a first inner profile 320, a first outer (sub-) profile 324, a second outer (sub-) profile 340, a third outer (sub-) profile 352, a flange 360, one or more channels 372, a first set of spring arms 366 and a second set of spring arms 368. In some embodiments, the support clip 300 may be cold-formed. For example, the support clip 300 may be stamped from a single sheet of metal.

Still referring to FIGS. 5-8, in some embodiments, the support clip 300 includes a support body 380 having a first end and a second end, opposite the first end. In some embodiments, the first set of spring arms 366 may extend from the first end of the support body 380. In some embodiments, the channel 372 of the first tier 308 may be defined at a first junction 384 between the first set of spring arms 366 and the support body 380. Referring to FIG. 8 in particular, in some embodiments, the second tier 312 may be defined by a first set of lateral arms 388 extending from the support body 380. Similarly, the third tier 316 may be defined by a second set of lateral arms 392 extending from the support body 380. In some embodiments, the first and second set of lateral arms 388, 392 extend integrally from the support body 380. In some embodiments, a first valley 394 (e.g., notch) may be disposed between the first set of lateral arms 388 and the second set of lateral arms 392. Furthermore, a second valley 396 (e.g., notch) may be disposed between the second set of lateral arms 392 and the flange 360. In some embodiments, the first and second valleys 394, 396 may define the channels 372 of the second tier 312 and the third tier 316 that are configured to receive and retain the edges of the aperture 120.

As illustrated in FIGS. 5-8, one of the first lateral arms 388 and one of the second lateral arms 392 may extend from each lateral side of the support body 380 (e.g., a side extending substantially parallel to the member axis 126, see FIG. 5). In some embodiments, the first and second sets of lateral arms 388, 392 may generally be planar (e.g., flat). However, as illustrated in FIGS. 5-8, in other embodiments the first and second sets of lateral arms 388, 392 may include distal bends. Specifically, the distal ends of the first and second sets of lateral arms 388, 392 may curve to extend toward an opposite lateral side of the support body 380.

Thus, the support clip 300 can be installed on a support structure to secure a corresponding elongate member using a similar approach as describe above for the support clip 200. For example, relative to FIG. 5, a method of supporting any of the elongate members 102 within the corresponding aperture 120 may include inserting the elongate member 102 into the aperture in the first insertion direction. The support clip 300 may correspondingly (e.g., afterwards) be inserted into the aperture 120 in the first insertion direction (or opposite) so that the first tier 308, the second tier 312, or the third tier 316 may engage the edges of the aperture 120. The first or second set of spring arms 366, 368 may correspondingly resiliently engage the elongate member 102 to help secure the elongate member 102 within the relevant aperture 120.

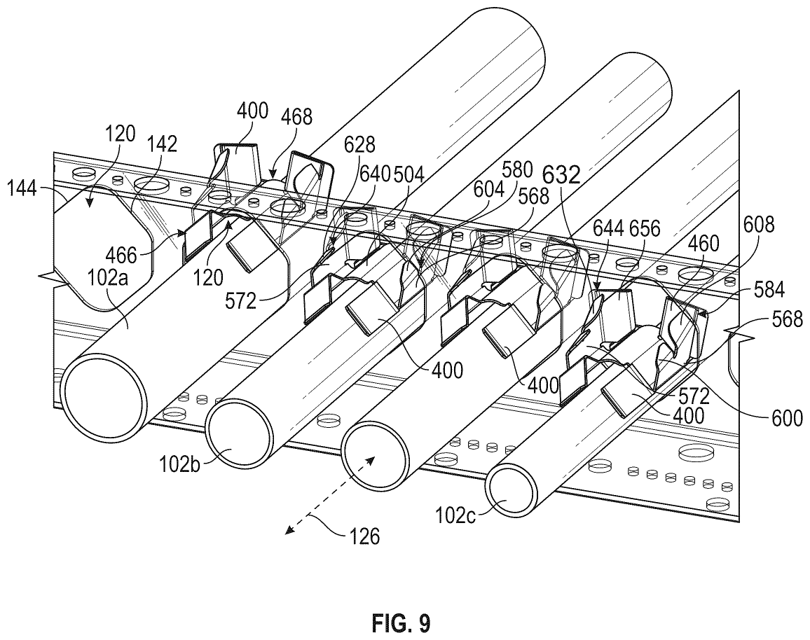

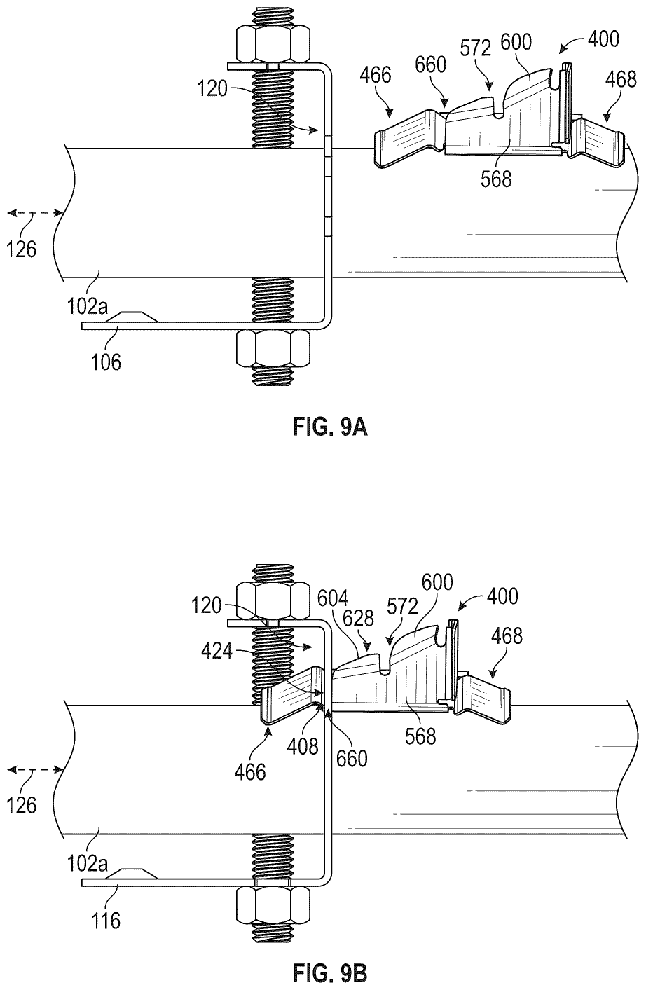

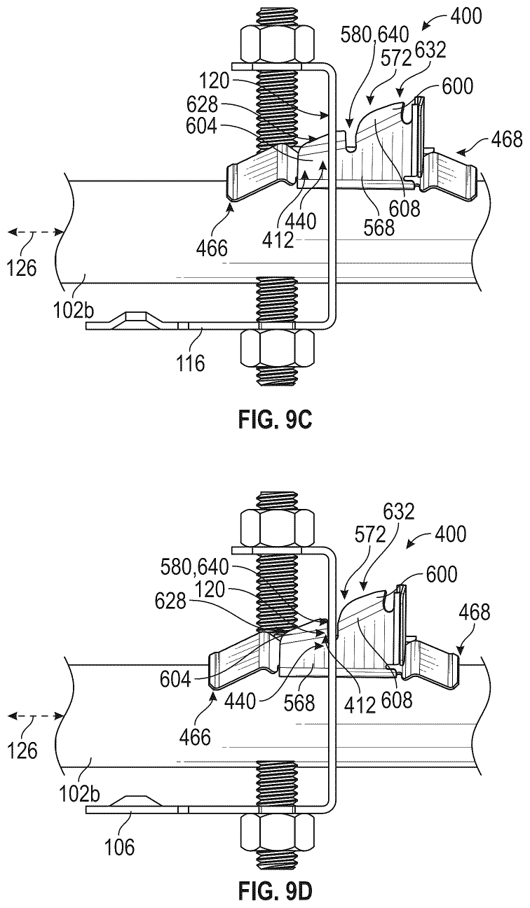

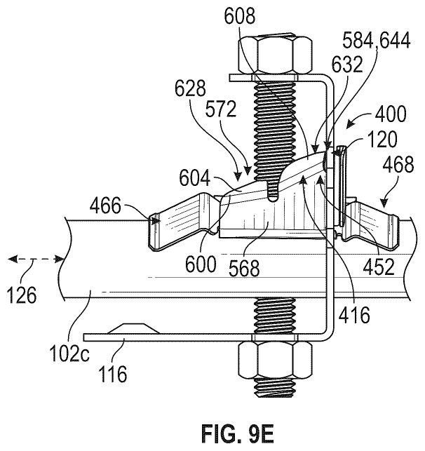

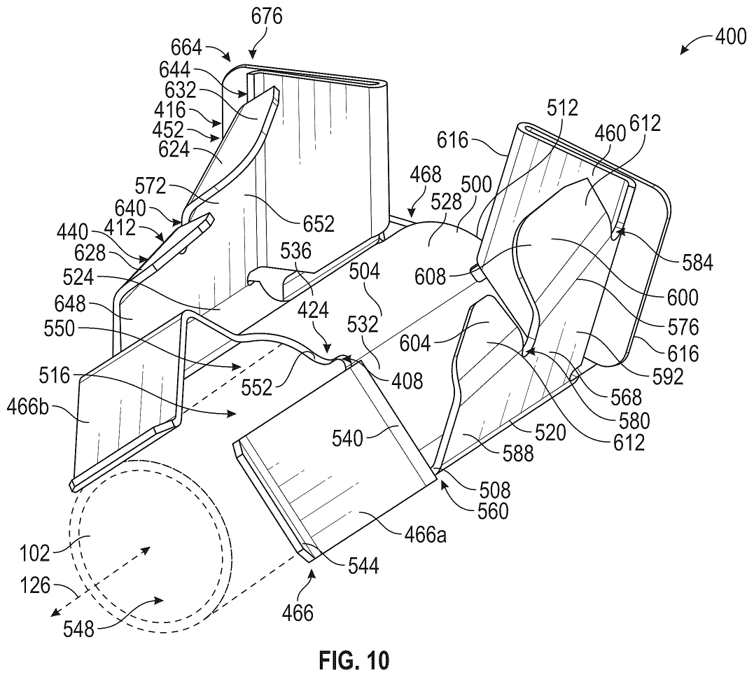

In some examples, a support can further include an alternate tiered structure. For example, FIGS. 9-14 illustrate another embodiment of a support 400. The support 400 of FIGS. 9-14 may generally include similar features as the support clip 200 of FIGS. 1-4 and the support clip 300 of FIGS. 5-8, including but not limited to a first tier 408, a second tier 412, a third tier 416, an outer profile that includes a first outer (sub-) profile 424, a second outer (sub-) profile 440, a third outer (sub-) profile 452, a flange 460, a first set of spring arms 466 and a second set of spring arms 468 (see FIG. 10). Thus, discussion of the support clips 200, 300 above also generally applies to similar components of the support clip 400 (and vice versa). In some embodiments, the support clip 400 may be cold-formed. For example, the support clip 400 may be stamped from a single sheet of metal.

Referring to FIGS. 9-14, in some embodiments, the support clip 400 includes a support body 500. The support body 500 may include a bridge section 504 that extends from a first axial end 508 to a second axial end 512, opposite the first end 508. As illustrated in FIG. 10, when the support clip 400 is installed on the elongate member 102, the bridge section 504 extends axially relative to the member axis 126, from the first end 508 to the second end 512.

In some examples, the bridge section 504 may define a bridge inner profile 516 that faces radially inwardly (e.g., toward the respective conduit 102). For example, the bridge inner profile 516 may be defined by the surfaces of the bridge section 504 that face the conduit 102. As described further below, a shape of the bridge inner profile 516 may conform, at least partially, to an outer profile of the conduit 102.

In some examples, the bridge section 504 may curve at least partially around the member axis 126. Referring to FIG. 10, the bridge section 504 may extend laterally from a third lateral side 520 to a fourth lateral side 524. In some examples, the third and fourth lateral sides 520, 524 may each connect the first and second axial ends 508, 512. In some examples, a width 526 may be measured laterally between the third and fourth sides 520, 524 (as illustrated in FIG. 14). The width 526 may determine, in part, a size of the elongate member 102 that the support clip 400 is configured to support.

In some examples, the bridge section 504 may curve between the third and fourth sides 520, 524. For example, as illustrated in FIG. 10, the bridge section may include a central bend 528. The central bend 528 may be aligned along a midline between the third and fourth sides 520, 524. The central bend 528 may be curved such that the bridge inner profile 516 at least partially surrounds the elongate member 102, and thus the member axis 126.

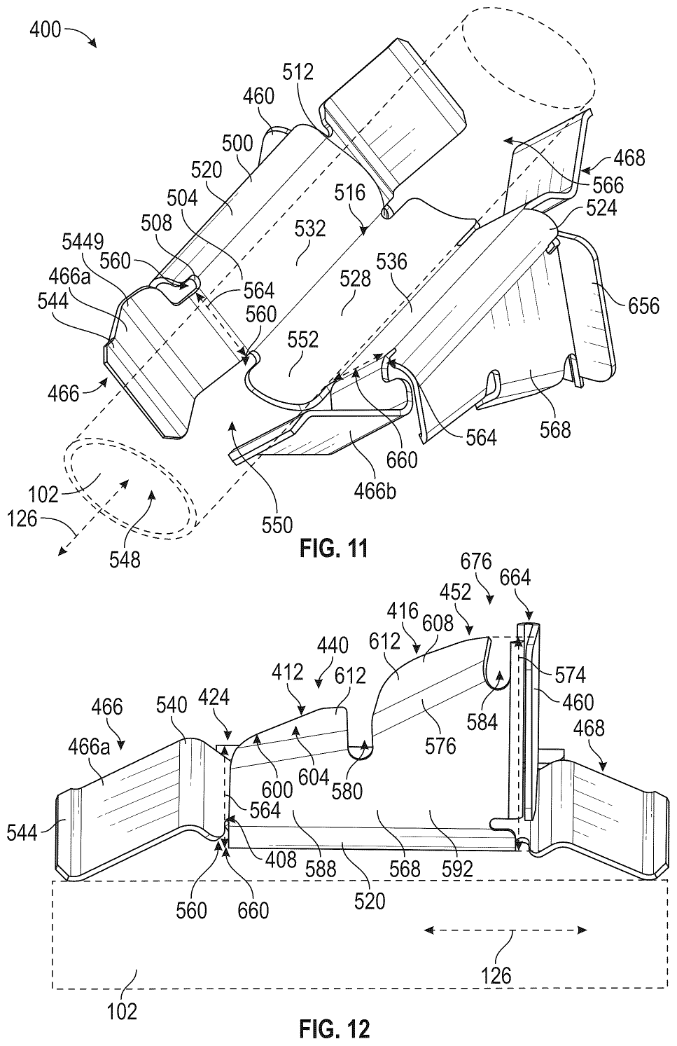

Referring to FIG. 11, in some examples, the bridge section 504 may include a first bridge side 532 that extends from the central bend 528 to the third side 520. Furthermore, the bridge section 504 may include a second bridge side 536 that extends from the central bend 528 to the fourth side 524. In some examples, the first and second bridge sides 532, 536 may be planar. Furthermore, the first bridge side 532 and the second bridge side 536 may extend from the central bend 528 to the third and fourth lateral sides 520, 524, respectively, radially inward relative to the member axis 126. Specifically, the third and fourth sides 520, 524, may be disposed radially closer to the member axis 126 than the central bend 528.

Referring again to FIG. 10, in some embodiments, the body 500 may include the first set of spring arms 466 that extend from the first end 508 of the bridge section 504 in a first axial direction relative to the member axis 126. Furthermore, the body 500 may include the second set of spring arms 468 that extend from the second end 512 of the bridge section 504, in a second axial direction opposite the first axial direction. In some examples, the first and second sets of spring arms 466, 468 may be configured to contact the elongate member 102 at locations that are spaced axially apart from the bridge section 504, relative to the member axis 126 (as shown in FIG. 12)—and spaced apart from each other. Axially spacing the points of contact between the first and second sets of spring arms 466, 468 and the elongate member 102 from the bridge section 504 (and each other) may advantageously distribute the force applied by the support clip 400 to the elongate member 102. Furthermore, as described further below, the first and second sets of spring arms 466, 468 may be resiliently deflectable relative to the bridge section 504 to allow the first and second sets of spring arms 466, 468 to resiliently engage the elongate member 102 having a range of diameters. In this regard, a larger spacing between contact points for the spring arms 466, 468 can also be beneficial.

In some examples, the first and second sets of spring arms 466, 468 may each define an inner spring arm profile that faces radially inwardly (e.g., toward the respective elongate member 102). For example, the inner spring arm profiles may be defined by the surfaces of the first and second sets of spring arms 466, 468 that face the elongate member 102. Additionally, as described further below, a shape of the inner spring arm profiles may conform, at least partially, to an outer profile of the elongate member 102 to better engage an exterior surface of the elongate member 102. For example, as detailed below, the arms 466, 468 can define respective V-shaped profiles to accommodate a wide range of conduit diameters.

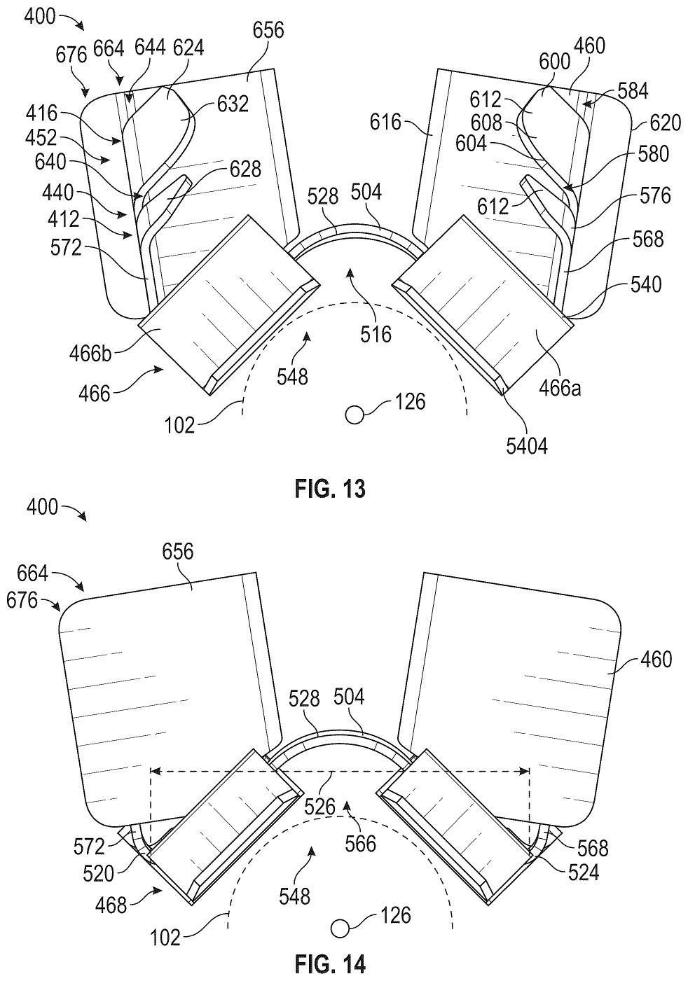

In some examples, the first set of spring arms 466 may include a first arm 466a and a second arm 466b, each extending from the first end 508 of the bridge section 504. As illustrated in FIG. 10, the first spring arm 466a may extend radially outwardly from the bridge section 504, relative to the member axis 126, to a first bend 540. Specifically, the first bend 540 may be disposed radially farther from the member axis 126 than the bridge section 504 (as shown in FIG. 13). At the first bend 540, the first spring arm 466a may curve to extend radially inwardly relative to the member axis 126 (e.g., toward the member axis 126). Furthermore, the first spring arm 466a may extend from the first bend 540 to a lip 544. At the lip 544, the first spring arm 466a may deflect to again extend radially outward.

In some examples, the lip 544 of the first spring arm 466a may define a distal end of the first spring arm 466a, opposite the bridge section 504. As illustrated in FIGS. 10 and 13, the lip 544 of the first spring arm 466a may be positioned radially inward of the bridge inner profile 516. Specifically, the lip 544 may be positioned closer to the member axis 126 than the first end 508 of the bridge section 504 (relative to an installed orientation). In some examples, the second arm 466b may be substantially identical to the first arm 466a. In other examples, the second arm 466b may define an alternate shape or one or more alternate characteristics.

In some examples, the first arm 466a may be positioned relative to the second arm 466b to create a first inner spring arm profile 548 for receiving and engaging the elongate member 102. Specifically, the first inner spring arm profile 548 may be collectively defined by the surfaces of the first and second spring arms 466a, 466b that face the elongate member 102. In some examples, the first arm 466a of the first set of spring arms 466 may be spaced from the second arm 466b in a direction that is transverse to the member axis 126. Consequently, a gap 550 may be formed between the first arm 466a and the second arm 466b and the arms 466a, 466b can be separately movable to better accommodate a range of installation contexts and approaches.

Still referring to FIG. 10, in some examples, a tongue 552 may extend from the bridge section 504 within the gap 550 between the first spring arm 466a and the second arm 466b. Specifically, the tongue 552 may extend from the central bend 528 in the first axial direction. In some embodiments, the tongue 552 may be a result of relief cuts 560 that extend into the bridge section 504. The relief cuts 560 may increase a length of the arms 466a, 466b and provide separation between the spring arms 466a, 466b and the bridge section 504. In some examples, the bridge section 504 may also include relief cuts 560 at a junction between the first end 508 of the bridge section 504 and the third and fourth sides 520, 524. As described further below, the relief cuts 560 may improve the ability of the arms 466a, 466b to deform relative to the bridge section 504, and the tongue 552 may otherwise provide for an advantageous installation process.

In some examples, the first and second sets of spring arms 466, 468 may be resiliently deflectable relative to the bridge section 504 to resiliently engage the elongate member 102. Specifically, the spring arms 466a, 466b may be resiliently deflectable about deflection axes 564 that extend transverse to the member axis 126. In some examples, the deflection axes 564 may extend between the relief cuts 560 positioned at the junction between the first end 508 of the bridge section 504 and the third and fourth sides 520, 524, and the relief cuts 560 positioned on either side of the tongue 552. The relief cuts 560 may locally weaken the spring arms 466a, 466b along the deflection axes 564 to ease the deflection of the first and second spring arms 466a, 466b. Consequently, the first inner spring arm profile 548 may be allowed to increase and decrease in size to orient the inner spring arm profiles to engage the elongate member 102 having a range of diameters. For example, the first and second arms 466a, 466b may be resiliently deflectable relative to the bridge section 504 to allow the elongate member 102 having a larger diameter to be retained within the first inner spring arm profile 548.

In some examples, the first arm 466a may be angled relative to the second arm 466b (e.g., at a non-parallel angle, as measured relative to the lateral direction). As illustrated in FIG. 13, the first arm 466a being angled relative to the second arm 466b may create the first inner spring arm profile 548 that is V-Shaped. For example, the shape of the first inner spring arm profile 548 taken transverse to the member axis 126 may be V-shaped at multiple locations between the bridge section 504 and the distal end of the first arm 466a, including at the lip 544. The V-shaped first inner spring arm profile 548 defined by the first and second arm 466a, 466b may taper toward the gap 550. In such examples, the elongate member 102 retained by the support clip 400 may be encouraged toward the gap 550 by the first inner spring arm profile 548, thus aiding the engagement and retention of the elongate member 102 by the support clip 400 and the first set of spring arms 466. However, in other examples, the first inner spring arm profile may define another relevant shape, such as a U-shape or any other applicable shape.

In some examples, the second set of spring arms 468 may also include a first arm and a second arm that defines a second inner spring arm profile 566 that is substantially identical to the first inner spring arm profile 548 (as shown in FIGS. 13 and 14). However, in other examples, the first and second inner spring arm profiles 548, 566 can define different shapes or characteristics. For example, a distance between the first bend 540 and the lip 544 of the first spring arm 466a of the first set of spring arms 466 may be greater than a distance between a first bend and a lip on the first spring arm of the second set of spring arms 468, or other geometries may vary.

In some examples, the support clip 400 may include a plurality of lateral arms that define respective outer profiles configured to engage the trapeze member 116 to aid the retention of the elongate members 102 within the apertures 120. As illustrated in FIG. 10, a first lateral arm 568 may extend radially outward from the third lateral side 520 of the bridge section 504 (e.g., away from the member axis 126). Furthermore, a second lateral arm 572 may extend radially outward from the fourth lateral side 524 of the bridge section 504 (e.g., away from the member axis 126).

In some embodiments, the first and second lateral arms 568, 572 may be symmetric about a plane extending radially from the member axis 126 through a midpoint between the third and fourth lateral sides 520, 524. Referring briefly to FIG. 12, the first lateral arm 568 may extend radially outwardly, relative to the member axis 126, a distance 574 from the third lateral side 520 that is measured between the third lateral side 520 and a maximum distal end (e.g., a point farthest from the member axis 126) of the first lateral arm 568. In some embodiments, the second lateral arm 572 may extend from the fourth lateral side 524 a distance that is similar or identical to the distance 574. However, in other examples, the first and second lateral arms 568 may extend dissimilar distances from the respective third and fourth 520, 524 and may be otherwise asymmetric.

In some examples, the first lateral arm 568 may extend from the third side 520 of the bridge section 504 to the distal end that defines various outer profiles to engage a support (e.g., the outer profiles 440, 452, as discussed above and below). In some examples, the outer profile(s) may taper between the first end 508 and the second end 512 of the bridge section 504. Specifically, the distal end of the first lateral arm 568 may taper radially outward relative to the member axis 126, along a perspective moving from the first end 508 to the second end 512 of the bridge section 504. As such, an outer profile (e.g., profile 440) that is adjacent the first end 508 of the bridge section 504 may be closer to the member axis 126 than an outer profile (e.g., profile 452) that is adjacent the second end 512 of the bridge section 504.

As illustrated in FIG. 10, the various outer profile(s) may be interrupted by one or more indents (e.g., valleys or notches), that extend at least part way from the distal edge of the first lateral arm 568 toward the junction with the third side 520 of the bridge section 504. The indents may be configured to receive edges of the apertures 120 of the trapeze member 116 to secure the support clip 400 and the elongate member 102 relative to the trapeze member 116. As described further below, the indents may thus allow the one or more outer profiles of the support clip 400 to securely retain different diameters of the elongate member 102 (e.g., as shown in FIG. 9).

In the illustrated example, the first lateral arm 568 includes a first indent 580 and a second indent 584. The first indent 580 may be axially offset from the second indent 584 relative to the member axis 126. Furthermore, the first indent 580 may extend farther toward the third side 520 of the bridge section 504 than the second indent 584. In some examples, the first indent 580 may separate a first lateral arm section 588 from a second lateral arm section 592, with corresponding sub-profiles of the outer profile of the first lateral arm 568. The first lateral arm section 588 may extend from the first end 508 of the bridge section 504 to the first indent 580. Furthermore, the second lateral arm section 592 may extend from the first indent 580 along the bridge section 504 to the second indent 584. In some examples the first flange 460 may extend from the second indent 584 opposite the second lateral arm section 592.

In some examples, a distal end of the first lateral arm may be angled toward the second lateral arm 572. For example, a first set of tapered wings 600 may extend (e.g., linearly) from a set of distal bends 576 toward the second lateral arm 572. In some examples, the first set of tapered wings 600 may extend obliquely or at other angles relative to the first lateral arm 568, and may generally extend laterally inwardly from a laterally outer extent of the arm 568. Furthermore, the first set of tapered wings 600 may extend radially outward from the relevant distal bend 576, relative to the member axis 126.

In some examples, the first set of tapered wings 600 includes a first wing 604 and a second wing 608. Specifically, the first wing 604 may extend from the first lateral arm section 588 and the second wing 608 may extend from the second lateral arm section 592. The first and second wings 604, 608 may be separated by the first indent 580.

As illustrated in FIG. 13, each of the first wing 604 and the second wing 608 of the first lateral arm 568 may taper radially outward relative to the member axis 126, along a direction from the first end 508 to the second end 512 of the bridge section 504. Specifically, a distal contact surface 612 of the first wing 604 and the second wing 608 may taper radially outward relative to the member axis 126, along a direction from the first end 508 to the second end 512 of the bridge section 504. In some examples, the distal contact surface 612 of the first wing 604 may taper at a different rate (e.g., angle) than the distal contact surface 612 of the second wing 608. Specifically, the distal wing end 612 of the first wing may be non-parallel to the distal wing end 612 of the second wing 608. Accordingly, the wings 604, 608 may be subjected to different reaction forces when the relevant contact surface 612 bears against an edge of a support opening during installation.

Still referring to FIG. 13, in some examples, the first wing 604 and the second wing 608 may be tiered. For example, the second wing 608 may extend radially farther outward than the first wing 604, relative to the member axis 126. Specifically, each point along the distal contact surface 612 of the second wing 608 may be disposed farther from the member axis 126 than each point along the distal contact surface 612 of the first wing 604. As described further below, the first wing 604 may be included in the second tier 412, while the second wing 608 is included in the third tier 416. Thus, for example, the first wing 604 can provide appropriate clearance for installation with smaller conduits to be secured by the second wing 608

Referring again to FIG. 10, in some examples, the first flange 460 may extend from the second indent 584 of the first lateral arm 568. The first flange 460 may extend from the second indent 584 perpendicular relative to the member axis 126. The first flange 460 may extend to a flange bend 616 in a first flange direction that is toward the second lateral arm 572. The first flange 460 may curve at the flange bend 616 to extend in a direction that is opposite the first flange direction. The first flange 460 may extend from the flange bend 616 to a distal flange end 620. In some examples, the first flange 460 may define a profile shape that is larger than the apertures 120 of the trapeze member 116, to ensure the support clip 400 is not advanceable within the aperture 120 past the first flange 460.

In some examples, the second lateral arm 572 may mirror the first lateral arm 568. For example, the second lateral arm 572 may include a second set of tapered wings 624 (e.g., a third wing 628 and a fourth wing 632) extending from a second distal arm edge. Furthermore, the second lateral arm 572 may include a second set of indents (e.g., a third indent 640 and a fourth indent 644). Similar to the first and second lateral arm sections 588, 592, the second lateral arm 572 may include third and fourth lateral arm sections 648, 652 delineated by the third indent 640. Furthermore, the third wing 572 and the fourth wing 632 may be separated by the third indent 640. In some examples, the second lateral arm 572 may include a second flange 656 extending from the fourth indent 644. As noted above, however, non-symmetric arrangements are possible in some cases, including arrangements with single arms rather than two laterally spaced arms.

In some examples, the support clip 400 may include spring arm indents 660 (e.g., channels) defined between the first set of spring arms 466 and the first and second lateral arms 568, 572. The spring arm indents 660 may be oriented transverse to the member axis 126, and may be aligned to receive edges of the aperture 120 to secure the support clip 400 against axial movement relative to the elongate member. For example, the spring arm indents 660 may be aligned along the deflection axes 564, and may extend from the third and fourth sides 520, 524 of the bridge section 504 to the tongue 552. Thus, the indents 660 may operate similarly to the indents 580, 584, as further discussed above, to engage edges of an opening to secure conduit.

In some examples, the support clip 400 can be configured to engage the trapeze member 116 to aid the retention of the elongate members 102 within the apertures 120. As described above, the support clip 400 may include the plurality of tiers. The plurality of tiers are configured to allow the support clip 400 to engage the elongate member 102 at any of a plurality of different diameters (as shown in FIG. 9). Furthermore, the support clip 400 may define a plurality of outer profiles, e.g., the shapes of which may be defined by surfaces of the tiers that face away from the elongate member 102. Thus, successive tiers may comprise structures that are disposed successively farther radially outward from the member axis 126, such that the first tier 408 comprises structures that are disposed closest to the member axis 126 and the fourth tier 664 comprises structures that are disposed farthest from the member axis 126. Accordingly, the various tiers can be selectively engaged with a support to secure conduit of different diameters.

Referring to FIG. 10, the support clip 400 may include the first tier 408. The first tier 408 may include the spring arm indents 660. In some examples, the first tier 408 may further include the tongue 552 and portions of the bridge section 504 that are proximate the first end 508 of the bridge section 504, such as the relief cuts 560. The first tier 408 may include the first outer profile 424, defined by surfaces of the spring arm indents 660 and the tongue 552 that face away from the elongate member 102. A shape of the first outer profile 424 may allow the first tier 408 to engage the trapeze member 116 to mitigate axial movement of the support clip 400 and the elongate member 102 relative to the trapeze member 116.

In some examples, the support clip may include the second tier 412. The second tier 412 may extend from the spring arm indents 660 to the first and third indents 580, 640. Specifically, the second tier 412 may include a portion of the first and second lateral arms 568, 572, including the first and third indents 580, 640, as well as the first and third lateral arm sections 588, 648. Additionally, the second ties 412 may include the first and third wings 604, 628 extending from the first and second lateral arms 568, 572. In other words, for example, the second tier 412 may include the second outer profile 440, as defined by surfaces of the first and second lateral arms 568, 572 that face away from the elongate member 102. A shape of the second outer profile 440 may allow the second tier 412 to engage the trapeze member 116 to mitigate axial movement of the support clip 400 and the elongate member 102 relative to the trapeze member 116.

In some examples, the support clip may include the third tier 416. The third tier 416 may extend from the first and third indents 580, 640 to the second and fourth indents 584, 644. Specifically, the third tier 452 may include a portion of the first and second lateral arms 568, 572, including the second and fourth indents 584, 644, as well as the second and fourth lateral arm sections 592, 652. Additionally, the third tier 416 may include the second and fourth wings 608, 632 extending from the first and second lateral arms 568, 572. In other words, for example, the third tier 416 may include the third outer profile 452, as defined by surfaces of the first and second lateral arms 568, 572 that face away from the elongate member 102. A shape of the third outer profile 452 may allow the third tier 416 to engage the trapeze member 116 to mitigate axial movement of the support clip 400 and the elongate member 102 relative to the trapeze member 116.

In some examples, the support clip may include a fourth tier 664. The fourth tier 664 may extend from the second and fourth indents 584, 644. Specifically, the fourth tier 664 may include the first and second flanges 460, 656. In other words, for example, the fourth tier 664 may include the fourth outer profile 676, as defined by surfaces of the first and second lateral arms 568, 572 (or of the flanges 460, 656, generally) that face away from the elongate member 102. A shape of the fourth outer profile 676 may allow the fourth tier 664 to engage the trapeze member 116 to mitigate axial movement of the support clip 400 and the elongate member 102 relative to the trapeze member 116. Furthermore, the fourth tier 664 including the first and second flanges 460, 656 may act as a finger hold or thumb tabs. Specifically, the user may squeeze the first and second flanges 460, 656 (e.g., toward one another) to flex or otherwise cause a deflection in the support body 500 (e.g., in the bridge section 504, the lateral arms 568, 572, or other components of the support clip 400) to ease the installation of the support clip 400 within the apertures 120. The squeezing or compressing of the first and second flanges 460, 656 may cause the first lateral arm 568 to move toward the second lateral arm 572 and vice versa. Utilizing the first and second flanges 460, 656 as thumb tabs may allow the user to install the support clip 400 within the aperture 120 without the assistance of a tool.

As also noted above, in some examples, the second and third outer profiles 440, 452 may be tapered tiered outer profiles. Specifically, as discussed above, the first and second sets of wings 600, 624 of the first and second lateral arms 568, 572, respectively, may taper radially outward relative to the member axis 126 in the direction from the first end 508 to the second end 512 of the bridge section 504. In other words, for example, the tiers 412, 416 may be tapered tiers.

Referring briefly to the second and third tiers 412, 416, in some examples, as described above, the distal end of the second and fourth wings 608, 632 may be disposed farther from the member axis 126 than the distal end of the first and third wings 604, 628. This arrangement can create a tiered relationship between the second and third tiers 408, 412, and thus also between the second profile 440 and the third profile 452. As illustrated in FIG. 12, the second tier 412, comprising the first and third wings 604, 628 may be separated from the third tier 416, comprising the first and third wings 604, 628, by the first and third indents 580, 640.

As illustrated in FIGS. 9 and 9B, the first outer profile 424 (and the first tier 408) may be configured to engage one or more of the edges of the aperture 120 to aid the retention of the elongate member 102a within the aperture 120. In particular, the spring arm indents 660 may be sized to engage (e.g., seat on) the third aperture edge 142 and the fourth aperture edge 144 (e.g., the lateral edges) to secure the elongate member 102a in a final installation position. In some examples, the first outer profile 224 may include the tongue 552 (see FIG. 10), which may engage a vertex disposed between the third aperture edge 142 and the fourth aperture edge 144 at the apex of the aperture 120 to assist in installation.

As shown in FIGS. 9 and 9C, the second outer profile 440 (and the second tier 412) may be configured to engage one or more of the edges of the aperture 120 to aid the retention of the elongate member 102b within the aperture 120. For example, the second outer profile 440 may be configured to engage the third aperture edge 142 and the fourth aperture edge 144 (e.g., the lateral edges). In some examples, the first and third arm indents 580, 640 may be sized to engage and receive the third aperture edge 142 and the fourth aperture edge 144 to secure the elongate member 102b in a final installation position.

As shown in FIGS. 9 and 9D, the third outer profile 452 (and the third tier 416) may be configured to engage one or more of the edges of the aperture 120 to aid the retention of the elongate member 102c within the aperture 120. For example, the third outer profile 452 may be configured to engage the third aperture edge 142 and the fourth aperture edge 144. In some examples, the second and fourth arm indents 584, 644 may be sized to engage and receive the third aperture edge 142 and the fourth aperture edge 144 to secure the elongate member 102c in a final installation position.

Referring to FIGS. 9A-9E, in particular, a method of supporting the elongate member 102 within the aperture 120 may include inserting the elongate member 102 into the aperture in the first insertion direction. The support clip 400 may correspondingly (e.g., afterwards) be inserted into the aperture 120 in the first insertion direction (or opposite) so that the first tier 408, the second tier 412, or the third tier 416 may engage the lateral edges 142, 144 of the aperture 120. The first or second set of spring arms 466, 468 may correspondingly resiliently engage the elongate member 102 to help secure the elongate member 102 within the relevant aperture 120 for a range of possible diameters.

Referring to FIG. 9A, prior to installation of the support clip 400, the support clip 400 may be arranged on the elongate member 102a, such that the first or second set of spring arms 466, 468 engage the elongate member 102. Referring to FIGS. 9A and 9B, the support clip 400 may be translated axially in the first direction along (e.g., in contact with) the elongate member 102a to a first installed configuration within the aperture 120 of the trapeze member 116.

Referring to FIG. 9B, as a distal end of the first of spring arms 466 (e.g., opposite the bridge section 504) is translated into the aperture 120, the first set of spring arms 466 may contact the edges of the aperture 120 and may resiliently deflect radially inward toward the member axis 126, to allow the first set of spring arms 466 to pass through the aperture 120. After the first bend 540 of the first set of spring arms 466 passes through the aperture 120, the first set of spring arms 466 may resiliently move to a first installed configuration. In the first installed configuration, the first set of spring arms 466 may secure the edges 142, 144 of the aperture 120 within the spring arm indents 660 of the first outer profile 424, between the first set of spring arms 466 and the first and second lateral arms 568, 572 (as shown in FIG. 9). Further, the second set of spring arms 468 may resiliently engage the elongate member 102a on an opposite side of the trapeze member 116 from the first set of spring arms 466, to further secure the elongate member 102a against unwanted movement (e.g., vibration).

In some examples, the tongue 552 may advantageously aid the insertion of the support clip 400 into the aperture 120, by contacting the apex of the aperture 120 and thus helping the support clip 400 to slip into the aperture 120 (e.g., via a levering movement of the clip 400 to deflect the spring arms 466, in combination with translation of the clip 400 into the aperture 120). Notably, although a particular diameter is shown for the elongate member 102a, the resilient and tapered configuration of the spring arms 466 can allow for easy and secure installation with elongate members of other (similar) diameters.

Referring to FIG. 9C, the elongate member 102b may define a smaller diameter than the elongate member 102a (see FIG. 9B). In such instances, the elongate member 102b may be better secured within the aperture 120 when the support clip 400 is in a second installed configuration. In order to move the support clip from the first installed configuration to the second installed configuration, the support clip 400 may be translated axially farther along the elongate member 102 in the first direction.

Still referring to FIG. 9C, as a distal end of the bridge section 504 is translated into the aperture 120, the first and third wings 604, 628 may contact the edges of the aperture 120. This contact may resiliently deflect the first and second lateral arms 568, 572 radially inward toward the member axis 126, e.g., in combination with deflection of the spring arms 466, 468, to allow the first and third wings 604, 628 to pass through the aperture 120. Correspondingly, for example, the first and second lateral arms 568, 572 may engage the edges 142, 144 of the aperture 120, to guide the edges 142, 144 of the aperture 120 into the first and third indents 580, 640. After the first and third wings 604, 628 pass through the aperture 120, the first and second lateral arms 568, 572 may resiliently move (e.g., return) to the second installed configuration, as illustrated in FIG. 9D.

In the second installed configuration, the edge of the aperture 120 may be secured within the first and third indents 580, 640 of the second outer profile 440, between the first and third wings 604, 628, and the second and fourth wings 608, 632, with the spring arms 466, 468 also resiliently engaging the elongate member 102b on opposite sides of the trapeze member 116. As similarly noted above, although a particular diameter is shown for the elongate member 102b, the resilient and tapered configuration of the spring arms 466 can allow for easy and secure installation with elongate members of a range of similar diameters.

Referring to FIG. 9E, the elongate member 102c may define a smaller diameter than the elongate member 102b (see FIG. 9D). In such instances, the elongate member 102c may be better secured within the aperture 120 when the support clip 400 is in a third installed configuration. In order to move the support clip from the second installed configuration to the third installed configuration, the support clip 400 may be translated axially still farther along the elongate member 102 in the first direction.

Still referring to FIG. 9E, as the support clip 400 is translated farther in the first direction, the second and fourth wings 608, 632 may contact the edges of the aperture 120 and may resiliently deflect the first and second lateral arms 568, 572 radially inward toward the member axis 126, e.g., in combination with deflection of the spring arms 466, 468, to allow the second and fourth wings 608, 632 to pass through the aperture 120. After the second and fourth wings 608, 632 pass through the aperture 120, the first and second lateral arms 568, 572 may resiliently move (e.g., return) to the third installed configuration shown in FIG. 9E.

In the third installed configuration, the edge of the aperture 120 may be secured within the second and fourth indents 584, 644 of the third outer profile 452, between the second and fourth wings 608, 632 and the flanges 460, 656 of the fourth outer profile 676. Correspondingly, the spring arms 466, 468 may also resiliently engage the elongate member 102b on opposite sides of the trapeze member 116 to hold the elongate member 102b against movement. Further, as similarly noted above, although a particular diameter is shown for the elongate member 102c, the resilient and tapered configuration of the spring arms 466 can allow for easy and secure installation with elongate members of a range of similar diameters

As noted above, in the first configuration, the second configuration, and the third configuration, the first or second set of spring arms 466, 468 may resiliently engage (e.g., resiliently deflect against) the elongate member 102 to help secure the elongate member 102 within the relevant aperture 120. Thus, for example, the first or second set of spring arms 466, 468 may induce a radially outward responsive force onto the support clip 400, to aid the engagement between the support clip 400 and the trapeze member 116 and thus generally further secure the elongate member 102.

In some examples, the first or second set of spring arms 466, 468 may flex relative to the bridge section 504 independently of resilient deflection of the first and second lateral arms 568, 572. Furthermore, in some embodiments, in the first configuration, the second configuration, and to the third configuration, or during transitions therebetween, the bridge section 504 may flex, such that the central bend 528 is deflected radially inwardly toward the member axis 126—or, in other words, the bridge sides 532, 536 (see, e.g., FIG. 11) may deflect radially outwardly away from the member axis 126.

In some examples, the shape of the first and second lateral arms 568, 572, including the taper (e.g., angle) of the first and second sets of wings 600, 624 as well as the general shape of the second and third outer profiles 440, 452 may provide for a smooth installation. For example, such shapes may encourage the lateral arms 568, 572 to naturally deflect laterally or radially inward as the support clip 400 is translated axially along the elongate member 102 to engage the first and second sets of wings 600, 624 with the edges of the aperture 120, while also helping to deflect the spring arms 466, 488 radially outwardly to accommodate a particular diameter of conduit, etc.

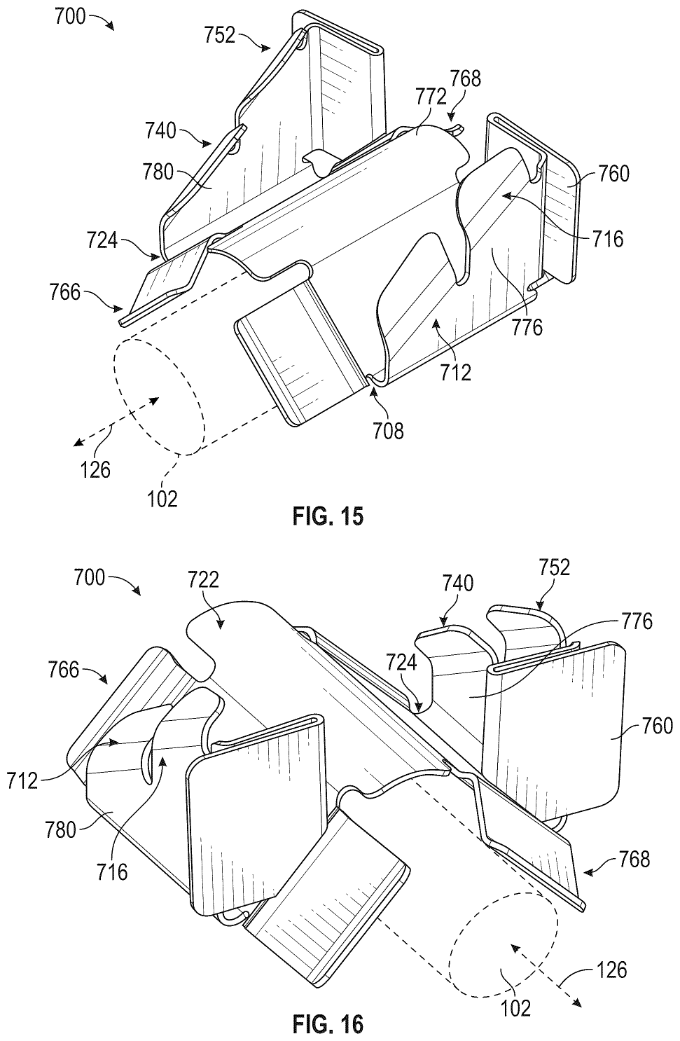

In some examples, a support can be cold formed, and can further include an alternate tiered structure. FIGS. 15-17 illustrate another embodiment of a support 700. The support 700 of FIGS. 15-17 may generally include similar features as the support clip 200 of FIGS. 1-4, the support clip 300 of FIGS. 5-8, and the support clip 400 of FIGS. 9-14, including but not limited to a first tier 708, a second tier 712, a third tier 716, a first outer (sub-) profile 724, a second outer (sub-) profile 740, a third outer (sub-) profile 752, a flange 760, a first set of spring arms 766, a second set of spring arms 768, a bridge section 772, a first lateral arm 776, and a second lateral arm 780. The support clip 700 may extend laterally between a third side 780 and a fourth side 784 along a width 788. Furthermore, the support clip 700 may include the first lateral arm 568 that may extend radially outwardly, relative to the member axis 126, a distance 792 from the third side 790 that is measured between the third lateral side 780 and a maximum distal end (e.g., a point farthest from the member axis 126) of the first lateral arm 776. Thus, discussion of the support clips 200, 300, 400 above also generally applies to similar components of the support clip 700 (and vice versa). In some embodiments, the support clip 700 may be cold-formed. For example, the support clip 700 may be stamped from a single sheet of metal.

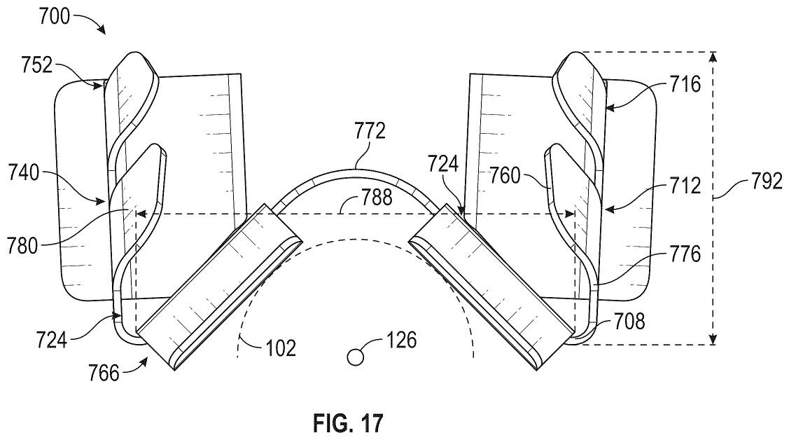

As illustrated by FIGS. 15-17, the relative dimensions of the support clip 700 can be varied to accommodate the elongate members 102 of various sizes, shapes, and diameters within the apertures 120 of various sizes, shapes, and diameters. The support clip 700 may be utilized to secure the elongate members 102 having larger diameters relative to the trapeze member 116. In order to account for an increase in size of the elongate members 102, the bridge section 772 may increase in width, measured transverse to the member axis, relative to the bridge section 672. For example, the width 788 measured laterally between the third and fourth sides 780, 784 (as illustrated in FIG. 17) of the support clip 700 may be larger than the width 526 of the support clip 400 to support the elongate member 102 having a larger diameter. Furthermore, due to the larger width 788, the lateral arms 776, 780 of the support clip 700 may be consequently spaced farther from one another.

In order to account for the change in size of the elongate members 102, or the apertures 120, the lateral arms 776, 780 may be modified to extend farther or less far from the bridge section 772. For example, the distance 792 that the first lateral arm 776 extends from the third side 780 of the support clip 700 may be larger than the distance 574 that the first lateral arm 568 extends from the third side 520 of the support clip 400, in order to support the elongate member 102 having a larger diameter, or to support the elongate member 102 within the aperture 120 having a larger diameter.

Thus, examples of the disclosed technology can provide improved systems for installing electrical wiring, conductors, conduit, and piping. Some examples provide a support assembly that is inexpensive to manufacture while providing an improved mechanism for reducing vibration of the electrical wiring, conductors, conduit, and piping after installation. Further, some examples may provide an improved method for reducing abrasion to the electrical wiring, conductors, conduit, and piping after installation, to prolong the life of the plumbing, data transfer, and electrical infrastructure in a building.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Also as used herein, unless otherwise limited or defined, “radially inward” indicates a direction that is at least partly toward a reference axis, a direction that is at least partly toward a reference axis or direction (i.e., has a non-zero, negative radial direction relative to a polar coordinate system with an origin at the reference axis). Unless otherwise limited or defined, “radially outward” indicates a direction that is at least partly away from a reference axis (i.e., has a non-zero, positive radial direction relative to a polar coordinate system with an origin at the reference axis).

Unless otherwise limited or defined, the terms “about” and “approximately,” as used herein with respect to a reference value, refer to variations from the reference value of ±20% or less (e.g., ±15, +10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive.

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

I claim:

1. A support assembly for conduit, the support assembly comprising:
a support member that extends in a lateral direction and includes an opening arranged to receive a conduit along an axial direction along a conduit axis; and
a support clip that integrally includes:
a bridge section extending axially to define a bridge inner profile that faces radially inwardly;
first and second lateral arms extending radially outwardly from opposite lateral sides of the bridge section to define respective first and second outer profiles, the first and second outer profiles each including indents selectively engageable with first and second lateral sides of the opening to secure the support clip against axial movement relative to the support member; and
spring arms extending from opposite axial ends of the bridge section to define inner spring arm profiles, the spring arms being resiliently deflectable relative to the bridge section to resiliently engage the inner spring arm profiles with a conduit at a range of conduit diameters.

2. The support assembly of claim 1, wherein, with the first and second lateral arms engaged with the first and second lateral sides of the opening, the spring arms are resiliently deflectable about axes transverse to the axial direction to orient the inner spring arm profiles at the range of conduit diameters.

3. The support assembly of claim 2, wherein one or more of the spring arms extends radially outwardly from the bridge section to a first bend, and radially inwardly from the first bend to the corresponding inner profile.

4. The support assembly of claim 2, wherein the one or more of the spring arms extends to a distal end that is radially outward from the inner profile.

5. The support assembly of claim 1, wherein the first and second outer profiles are tapered profiles.

6. The support assembly of claim 5, wherein the first and second outer profiles are tiered, tapered profiles.

7. The support assembly of claim 6, wherein tiers of the first and second outer profiles are separated by the indents of the first and second outer profiles.

8. The support assembly of claim 5, wherein a first distal end of the first lateral arm angles toward the second lateral arm along the first outer profile;
wherein a second distal end of the second lateral arm angles toward the first lateral arm along the second outer profile; and
wherein the first and second outer profiles taper in a radial direction along the first and second distal ends, axially along the bridge section.

9. The support assembly of claim 1, wherein the bridge section includes a central bend, a first bridge side extending radially inwardly from the central bend to the first lateral arm, and a second bridge side extending radially inwardly from the central bend to the second lateral arm; and
wherein first tapered wings extend from one or more distal bends of the first lateral arm toward the second lateral arm and second tapered wings extend from one or more distal bends of the second lateral arm toward the first lateral arm.

10. The support assembly of claim 9, wherein the first and second tapered wings are tiered, tapered wings, separated by the indents of the first and second outer profiles, respectively.

11. The support assembly of claim 1, wherein one or more first spring arms of the spring arms, extending from a first axial end of the opposite axial ends of the bridge section, define a spring arm indent selectively engageable with the first and second lateral sides of the opening to secure the support clip against axial movement relative to the support member.

12. The support assembly of claim 1, wherein the opening is polygonal and defines an apex, with the first lateral side of the opening and the second lateral side of the opening extending from opposite side of the apex.

13. A support clip for conduit, the support clip comprising:
a bridge section that is concave toward a reference conduit axis, including an apex bend, a first bridge side extending radially inwardly from a first lateral side of the apex bend and a second bridge side extending radially inwardly from a second lateral side of the apex bend, relative to the reference conduit axis;
a first lateral arm extending radially outwardly, relative to the reference conduit axis, from the first bridge side to a tapered, notched first outer profile;
a second lateral arm extending radially outwardly, relative to the reference conduit axis, from the second bridge side to a tapered, notched second outer profile;
one or more first spring arms extending radially inwardly, relative to the reference conduit axis, and in a first axial direction away from the bridge section; and
one or more second spring arms extending radially inwardly, relative to the reference conduit axis, and in a second axial direction away from the bridge section;
the first and second outer profiles being engageable with sides of an opening of a support member to secure the support clip against axial movement; and
the one or more first spring arms and one or more second spring arms being resiliently engageable, at a range of conduit diameters, with a conduit extending through the opening along the reference conduit axis.

14. The support clip of claim 13, wherein one or more notches of the first outer profile separate laterally angled wings of the first outer profile; and
wherein one or more notches of the second outer profile separate laterally angled wings of the second outer profile.

15. The support clip of claim 13, wherein the one or more first spring arms define one or more channels transverse to the reference conduit axis, aligned to receive one or more of the sides of the opening to secure the support clip against axial movement.

16. The support clip of claim 15, wherein the one or more channels define one or more deflection axes for the one or more first spring arms, to resiliently align the one or more first spring arms to engage the conduit at the range of conduit diameters.

17. A method of supporting conduit relative to a support member that extends in a lateral direction, the method comprising:
inserting a length of conduit in an axial direction into an opening in the support member, to extend along a conduit axis; and
inserting a support clip for conduit into the opening, in the axial direction, so that:
a bridge section of the support clip extends axially along the conduit, with a bridge inner profile facing radially inwardly relative to the conduit axis, and with first and second lateral arms extending radially outwardly from opposite lateral sides of the bridge section;
indents of first and second outer profiles of the first and second lateral arms selectively engage first and second lateral sides of the opening to secure the support clip against axial movement relative to the support member; and
spring arms that extend from opposite axial ends of the bridge section resiliently deflect relative to the bridge section to resiliently engage inner profiles of the spring arms with the conduit at a conduit diameter.

18. The method of claim 17, wherein the spring arms resiliently deflect about axes transverse to the conduit axis to engage the inner profiles with the conduit.

19. The method of claim 17, wherein inserting the support clip into the opening includes manually compressing the first lateral arm toward the second lateral arm, wherein inserting the support clip into the opening further causes inwardly angled wings of the first and second lateral arms to engage the first and second lateral sides of the opening, to guide the first and second lateral sides into corresponding notches of the first and second outer profiles.

20. The method of claim 17, wherein the spring arms collectively define one or more V-shaped inner profiles, spaced axially apart from the bridge section, to engage the conduit at the conduit diameter.
